(19) United States
(12) Patent Application Publication
(10) Pub. No.: US 2009/0091649 A1
(43) Pub. Date: Apr. 9, 2009

(54) ELECTRONIC DOCUMENT VIEWER

(76) Inventor: LEROY E. ANDERSON, BOISE, ID (US)

Correspondence Address: DYKAS, SHAVER & NIPPER, LLP, P.O. BOX 877, BOISE, ID, 83701-0877, US

(21) Appl. No.: 12/246,277

(22) Filed: Oct. 6, 2008

Related U.S. Application Data
(60) Provisional application No. 60/977,790, filed on Oct. 5, 2007.

(51) Int. Cl. H04N 5/222

(52) U.S. Cl. 348/333.01; 348/E09.002

(57) ABSTRACT

The invention is an electronic viewer for documents for use by visually impaired viewers. The unit includes a digital camera lens unit and a digital viewing screen unit for placement over a document. A zoom function allows the user to zoom to the lower center, to the right, left, lower left, or lower right of the screen in order to give the user inside the door a better view of portions of the document being viewed.

### CROSS-REFERENCE TO RELATED APPLICATIONS

This application claims the priority date of the provisional application entitled ELECTRONIC VIEWER filed by Leroy E. Anderson on Oct. 5, 2007 with application Ser. No. 60/977,790.

### FIELD OF THE INVENTION

The invention generally relates to an apparatus for assisting a user to view documents, and more particularly to a digital device for viewing and magnifying documents.

### BACKGROUND OF THE INVENTION

There is a need for people with vision limitations to use a device to magnify images to make it easier to read or view them. Devices exist for this purpose, in the form of magnifying lenses, or reader machines. The reader machines are large, bulky and expensive, and not portable. The magnifying lens devices are often not adequate and a device with improved magnification, lighting control, brightness control, and portability is needed.

### SUMMARY OF THE INVENTION

The invention is an electronic document viewer which includes a digital camera lens unit, a digital viewing screen unit, an off-center zoom feature, and a zoom activation button. The digital camera lens is configured for mounting on a stand which can be positioned over a document to be viewed. The digital viewing screen can be built into a device body along with the digital camera lens, or can be a separate unit, such as a computer monitor or a wall mounted flat screen TV monitor.

The digital view screen includes a zoom feature that selects a region in the displayed image for magnification with that region being a region other than the center of the image. The typical zoom lens zooms towards the center of the image and makes the center of an image larger. The zoom feature of this viewer zooms to a region that is not the center of the picture, and that, in one version, can be selectable by the user. For instance, the viewer may be configured to zoom to the lower center of the image. This kind of a zoom would be useful if the person outside the door is standing to the left or right of the center of the door, or if they are crouched lower than the typical field of view of a door viewer. Zooming to the center bottom of the image, in such a case, would allow the user behind the door to get a better image of a short person, or a person crouching below the field of view of the viewer, or a person standing to the left or right of the center of the screen.

A zoom activation button is included that can take a number of different forms which will be discussed below. An image which is viewed in the digital viewing screen is magnified when the zoom activation button is activated and the image is magnified to show greater detail in that part of the image which is selected.

A preferred version of the device is configured specifically to zoom in on the lower center of the displayed image. The zoom feature can be based on optics in the digital camera lens and also can be based on software enhancement of the image by digital manipulation. The zoom feature can also be specifically configured to zoom in on the lower right region of the image, or the lower left region of the image. The device can also be configured with the capacity to zoom in on more than one region of the image, with the selection of the region for zooming in being left to the user's control. In such a case, a zone selection button would be provided, which would allow the region of the image selected for magnification to be identified by the user. The zone selection button can be in the form of a touch screen button, such as allowing the user to merely touch the lower center, lower right, lower left, upper center, upper right, or upper left at his discretion, with the resulting magnification of that region of the image. The zone selection button can also take the form of a button which is activated repeatedly, and the selection area cycled through the different options of regions for magnification until the user selects which view he would like to have magnified.

The electronic viewer can also have a magnification button, with which the user selects from a number of different levels of magnification. The electronic viewer can also have a brightness button to allow the user to adjust the brightness of the image to a preferred level of brightness.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 is a perspective view of the document viewer of the invention.

FIG. 2 is a side view showing the document viewer of the invention.

FIG. 3 is a top view of the document viewer of the invention over a document.

FIG. 4 is a top view of the document viewer zoomed in on an image in lower center.

FIG. 5 is a front view of the document viewer with a remotely mounted display screen.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

The electronic viewer of the invention is shown in FIGS. 1-5. FIG. 1 shows a perspective view of the electronic viewer which includes a digital camera lens unit 12, which is located on the underside of the unit. FIG. 1 also shows a digital viewing screen unit 14 which in this version is mounted in the viewer body 20, but in other versions may be mounted separately from the viewer body. Also shown is a light source 40, legs which form a stand 100, a light switch 104, a brightness selection 48, and a touch screen zoom selection 44 which comprises the off center zoom feature 16 of the device. Also shown is a magnification button 50. This device would typically be placed over a document to be viewed and would provide the user with an enhanced view of the document which can include magnification, brightness adjustment, additional light from the light source, and a zoom which zooms to the non-center portions of the document such as to the left, to the right, and above and below. This provides the user with an enhanced view of the document in which he is able to shift the view displayed without moving the document viewer.

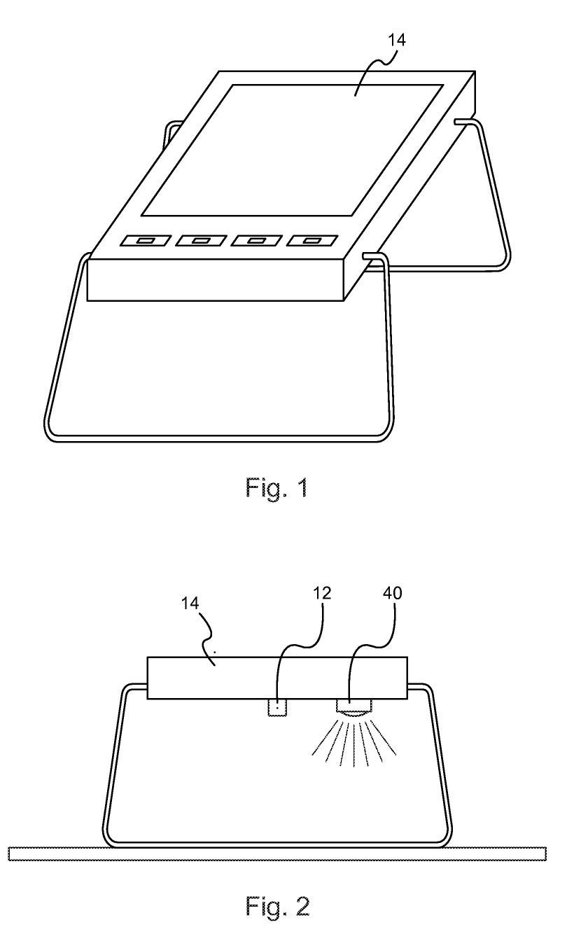

This version of the document viewer is also much lighter and more portable than units which are available. FIG. 2 shows a side view of the same unit shown in FIG. 1, with the light 40 visible on the underside of the device body 20, with the lens unit 12 pointed toward the work surface below and with the display for the digital viewing screen unit 14 on the top of the viewer body 20.

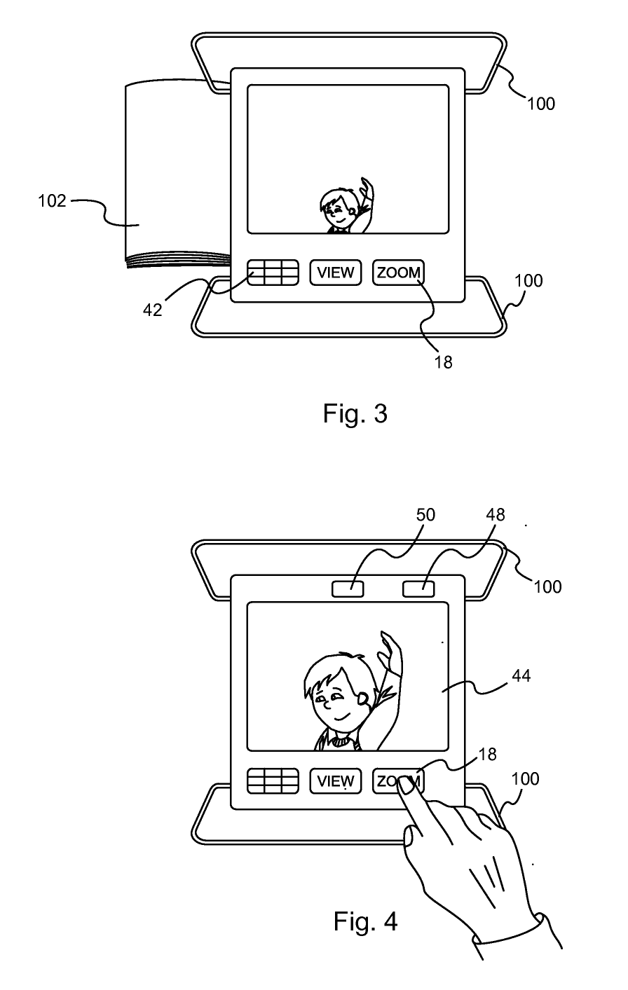

FIG. 3 shows a top view of the device 10 positioned over a document 102. Visible are the legs 100 which for a portable stand over the document, as well as the zoom point selection pad 42, a magnification button 50, a brightness button 48, and an off center zoom feature 16. Shown in the digital viewing screen 14 is an image from the underlined document which is positioned generally in the lower center of the viewing screen. Shown in FIG. 4 is the same device in which the selection to be enlarged has been defined as the lower center, and the image in the lower center is magnified and centered in the viewing screen unit 14.

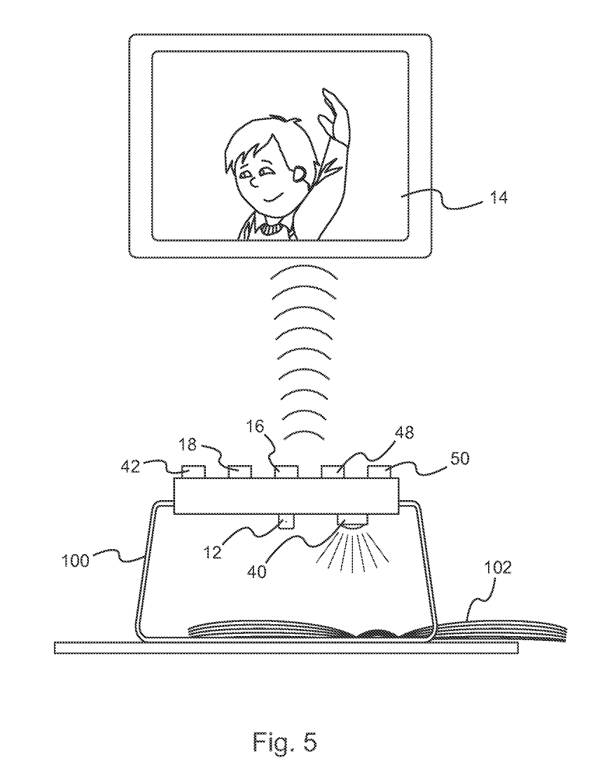

FIG. 5 shows the side view of the document viewer 10, positioned over a document 102. Shown is the light 40, the camera lens 12, the stand 100, and other features which were seen in the previous version. In this version the digital viewing screen unit 14 is positioned separately from the viewer body 20, and could be viewed on a lap top computer, or a T.V. monitor. Shown is a wireless transmission 96 in which the image is sent from the camera to the viewing screen unit 14.

Shown in FIG. 4 is the zoom point selection pad which is configured as a touch screen monitor. By touching the region of the screen to be magnified, and pressing the magnification button 50, a non-centered part of the image that is viewed may be enlarged and moved towards the center of the viewing screen 14.

The electronic viewer 10 of the invention also has the capability of zooming in on an object with a zoom feature which zooms to an off-center region of the screen. It is common in the prior art for an electronic viewing device to zoom straight forward and to magnify the portion of the screen which is in the center of the screen. This is generally a workable practice in Items such as cameras. However, in a viewer which is utilized in a document viewing situation, it is more advantageous to zoom to an area that is not in the center of the view screen. This requires the use of a zoom point selection pad which can be in the form of a pad of buttons shown in FIG. 3, or can be in the form of a touch screen zoom selection such as shown in FIG. 4. By choosing the area to zoom towards, the view screen zooms, for instance, to the lower bottom of the screen, the lower left or right, the right side of the screen, the left side of the screen, or the center left or right upper part of the screen.

FIG. 3 shows an image in the lower center of the view screen 14. When a selection is made on the zoom point selection pad 42 to zoom to the lower center of the screen, the view changes to that shown in FIG. 4. Shown in FIG. 3 is a view button 24 which activates the unit and a zoom button 16 which controls the amount of magnification of the image.

FIG. 4 also shows a magnification button 50, and a brightness button 48. The brightness button 48 can be tapped to brighten the image on the view screen.

The version of the electronic document viewer of the invention which is configured to act as a reading aid can include the digital viewing screen mounted into the same unit with the camera, and positioned on a stand with spacer legs to hold the unit above the printed material. The digital viewing screen can also be removable and portable from the digital camera lens on the stand to allow a person to read the information being illuminated and magnified from a position of their choice. This version would have the ability to magnify the image and enhance the brightness of the image.
A. Camera and monitor combined with a base with regular screen with button for selecting viewing area.
B. Camera and monitor combined with a base with regular screen with button for magnification.
C. Camera and monitor combined with a base with regular screen with button for light.
D. Camera and remote monitor for any of the above.

Note: Any of the above programs may be used with a night or low light camera and with or without L.E.D. light or lights.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined in the following claims.

1. An electronic document viewer, comprising:
a digital camera lens unit for placement over a document to be viewed;
a digital viewing screen unit for viewing an image of a document from said camera lens;
a stand for supporting said document viewer above a document to be viewed;
a zoom feature in which a selected region of said image is magnified, in which the region magnified is a region other than the center of the image of said region to be viewed;
a zoom activation button; wherein
an image viewed in the digital viewing screen is magnified when said zoom activation button and said image is magnified to show greater detail of a part of the image which is not the center of the image.

2. The electronic document viewer of claim 1 in which said zoom feature is configured to magnify a region of said image located in the lower center of said image.

3. The electronic document viewer of claim 1 in which said zoom feature is based on software magnification of said image.

4. The electronic document viewer of claim 1 in which said zoom feature is configured to magnify a region of said image located in the lower right of said image.

5. The electronic document viewer of claim 1 in which said zoom feature is configured to magnify a region of said image located in the lower left of said image.

6. The electronic document viewer of claim 1 in which said zoom feature is configured to magnify one of a plurality of regions of said image in which the region to be magnified is not the center of the image.

7. The electronic document viewer of claim 6 in which said electronic document viewer further comprises a zone selection button for selecting a region of said image to magnify.

8. The electronic document viewer of claim 6 in which said electronic document viewer further comprises a zone selection button in the form of a touch screen for selecting a region of said image to magnify.

9. The electronic document viewer of claim 1 in which said zoom feature is configured to magnify one of a plurality of regions of said image in which the region to be magnified is not the center of the image.

10. The electronic document viewer of claim 7 which further comprises a magnification button to change magnification to different levels of magnification.

11. The electronic document viewer of claim 7 which further comprises a brightness button to change brightness of said image to different levels of brightness.

12. The electronic document viewer of claim 2 in which said digital camera lens is configured for mounting in a stand for placement above printed material, to serve as a reading aid.

13. The electronic document viewer of claim 12 which further includes a light source for illuminating said printed material.

14. The electronic document viewer of claim 2 in which said digital viewing screen is configured to be portable from said digital camera lens for placement in any location chosen by a user.

15. The electronic document viewer of claim 14 which further comprises a magnification selection means for selecting different levels of magnification for the image selected form the various cameras.
